(19) United States
(12) Patent Application Publication
(10) Pub. No.: US 2014/0158794 A1
(43) Pub. Date: Jun. 12, 2014

(54) MOBILE CARWASH SYSTEM

(71) Applicant: Henry Wilkinson, Durban (ZA)

(72) Inventor: Henry Wilkinson, Durban (ZA)

(21) Appl. No.: 13/994,413

(22) PCT Filed: Nov. 15, 2011
(86) PCT No.: PCT/ZA2011/000088

§ 371 Date: Aug. 21, 2013

(30) Foreign Application Priority Data
Dec. 15, 2010 (ZA) 2010/09052

(51) Int. Cl. B60S 3/04

(52) U.S. Cl. CPC B60S 3/044
USPC 239/172; 239/373; 239/303

(57) ABSTRACT

The invention provides for a mobile vehicle washing unit. The mobile vehicle washing unit includes a portable dispensing unit having at least one reservoir for storing a liquid detergent under pressure and a spray applicator for applying the pressurised detergent to a vehicle. The reservoir includes a rubber bladder housed therein under pressure, the bladder being fillable with the liquid detergent.

### TECHNICAL FIELD OF THE INVENTION

This invention relates to a mobile carwash system.

### BACKGROUND ART

Mobile car wash systems have become increasingly popular, with a number of different car washing operations available in public parking lots, more specifically in the parking lots of shopping malls.

The advantage of these systems is that the owner of the car can have his car cleaned, while attending to other matters, thus alleviating the concern that he is wasting time.

Mobile detailing services have also become increasingly popular in a number of countries. In this instance, the service travels to the vehicle, either at home or place of business, and completely cleans and details the car while it is parked and otherwise unneeded. These mobile detailing service professionals utilize a variety of cleaning tools, solutions, and products, and must transport them to each location.

There are a number of drawbacks to the mobile car washing units currently in operation. Most of them require an available water source to which the unit can connect. This limits the true mobile potential of the unit. Other devices are further limited in their mobility in that they rely upon external power and air supply, often in addition to a water source.

Alternative types of mobile cleaning apparatus still depend upon water, but attempt to provide an on-board water supply tank; thus, eliminating the need to connect to an external water source. Some also have the ability to rely on battery power to enable free movement. However, the tank size, in addition to the considerable weight of multiple litres of water, inhibit mobility and manoeuvrability of the unit.

Furthermore, with water becoming an ever-more precious commodity, there is a need for a means of washing motor vehicles which at least limits the amount of water used.

It is an object of this invention to provide a mobile car wash system which, at least partially, alleviates some of the abovementioned problems. SUMMARY OF THE INVENTION

In accordance with this invention, there is provided a mobile vehicle washing unit comprising a portable dispensing unit capable of retaining and dispensing at least a liquid detergent for application to the body and windows of a vehicle; the dispensing unit including at least a first reservoir for storing the liquid detergent under pressure and a spray applicator for applying the pressurised detergent to the vehicle; the first reservoir including a rubber bladder housed therein under pressure, the bladder being re-Tillable with the liquid detergent.

The use of the pressurised rubber bladder to store the liquid detergent under pressure enables the dispensing of the detergent through the spray applicator without the need of an independant compression unit or a power supply.

The first reservoir may be pressurised to approximately 2 bar pressure by introducing compressed air into the reservoir through an attached one-way pneumatic valve.

The liquid detergent may be pumped into the bladder housed within the first reservoir from an external supply until the reservoir is pressurised to approximately 7 bar pressure.

It is envisaged that a pump driven by a motor will pump the detergent into the bladder until a pressure of approximately 7 bar is reached.

The detergent is subsequently stored in the rubber bladder under pressure until it is required to be sprayed onto a vehicle. The pressure exerted on the liquid detergent by the rubber bladder allows the detergent to be emitted from the bladder via a spray applicator. The spray applicator may include a hose, attached to the bladder at one end and to a trigger jet and spray nozzle at the other end.

It is possible for the pressurised rubber bladder to be refilled with liquid detergent from time to time, as and when required.

The liquid detergent is preferably a combined wash and wax solution. In a preferred aspect of the invention, the wash and wax solution is not required to be rinsed off the vehicle.

The dispensing unit may be mounted on wheels.

The dispensing unit preferably includes at least two wheels attached to its undercarriage, and may include a third castor wheel mounted in front of or behind the two wheels. The castor wheel may include a braking device.

The dispensing unit may additionally include a second reservoir for storing clean water, for use in rinsing cloths and other peripherals associated with the cleaning of the vehicle, and a third reservoir for storing waste water.

The clean water reservoir includes a hand operated manual pump for pumping the water out of the tank.

The dispensing unit may also include a basin and plug for receiving pumped water from the clean water reservoir. The basin is preferably connected to the waste water reservoir.

The dispensing unit may further include storage compartments for housing additional vehicle cleaning accessories and products. The additional vehicle cleaning accessories and products may include, but are not limited to cloths, brushes, chamois, trim and tyre shine, rim and mag cleaner and a heavy duty cleaner.

The unit may additionally include storage space for a portable vacuum cleaner.

More specifically, in a preferred embodiment, the invention provides a portable dispensing unit for housing equipment and materials for washing and cleaning vehicles. The unit comprising; two front wheels attached to its under carriage, and a third castor back wheel; a base supporting three reservoirs, at least one of the reservoirs including an internal pressurised rubber bladder; and a housing surrounding the base platform, protectively covering the reservoirs held therein.

The housing may additionally include a basin and plug located on the exterior top of the housing, for receiving and holding water from the clean water reservoir and connectable to the wastewater reservoir.

The housing may also include a lid, hingeably attached to the housing, for covering the basin.

The interior of the lid may include storage compartments for storing various vehicle cleaning products and accessories.

The housing is preferably manufactured from a fibreglass material.

### BRIEF DESCRIPTION OF THE DRAWINGS

A preferred embodiment of the invention is described below by way of example only and with reference to the following drawings, in which;

FIG. 1 is a representation of the mobile dispensing unit;

FIG. 2 is a representation of the top of the mobile dispensing unit, as protected by the lid;

FIGS. 3 and 4 depict the reservoirs of the mobile dispensing unit as located inside the housing.

### DETAILED DESCRIPTION OF THE PREFERRED EMBODIMENT

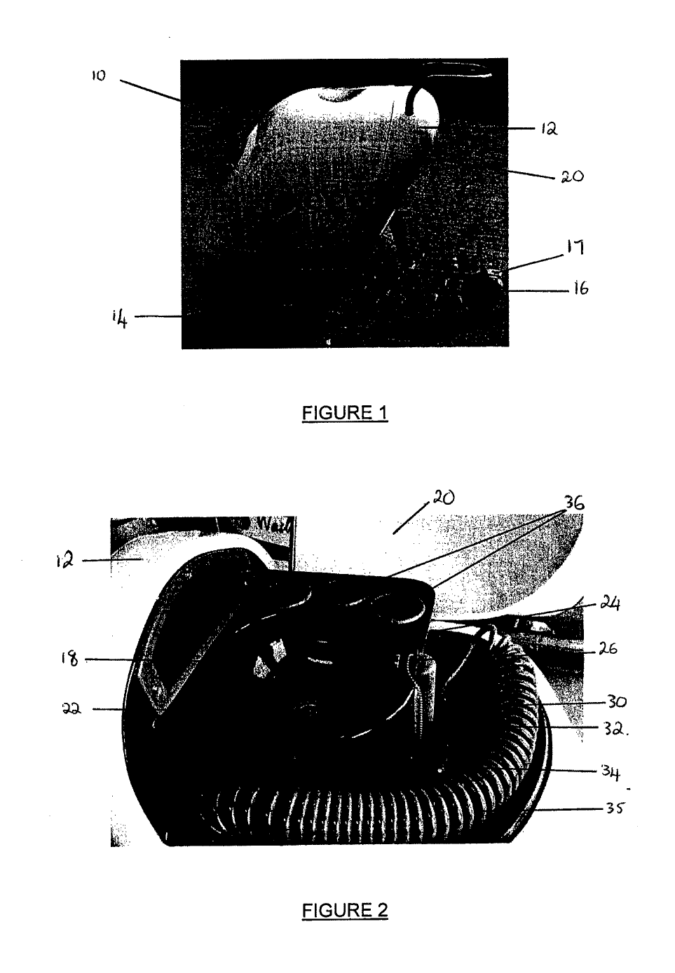

Referring to FIGS. 1 and 2 in which like features of the invention are indicated by like numerals.

The mobile vehicle washing unit 10 includes a fibreglass housing 12 having two front wheels 14 attached to it's under carriage, and a third castor back wheel 16, which includes a braking device 17. Three reservoirs are protectively housed inside the housing 12. The reservoirs include a fresh water reservoir, a waste water reservoir and a detergent reservoir.

A lid 20 covers a basin 18 located on top of the housing 12. A plug (not shown) and plug hole 22 allow the basin 18 to be filled and drained with ease. The waste water reservoir is located directly below the basin, and is connected to the plug hole 22. A hand pump 24 and faucet 26, connected to the fresh water reservoir, also located below the basin 18 enable fresh water to be pumped from the fresh water reservoir into the basin 18. The water in the basin 18 may be used to rinse the cloths used to clean the vehicle.

A spray applicator 30 including a trigger 32 and nozzle 34 is attached to the detergent reservoir by a hose 35 and is used to spray the pressurised liquid detergent onto the vehicle.

Bottle holders 36 are located next to the basin and are used to hold bottles of additional vehicle cleaning products such as trim and tyre shine, rim and mag cleaner and a heavy duty cleaner. Further storage compartments may also be located in the lid of the housing to store vehicle cleaning such as cloths, brushes, and chamois.

A portable vacuum cleaner (not shown) may be stored over the castor wheel 16 of the unit 10.

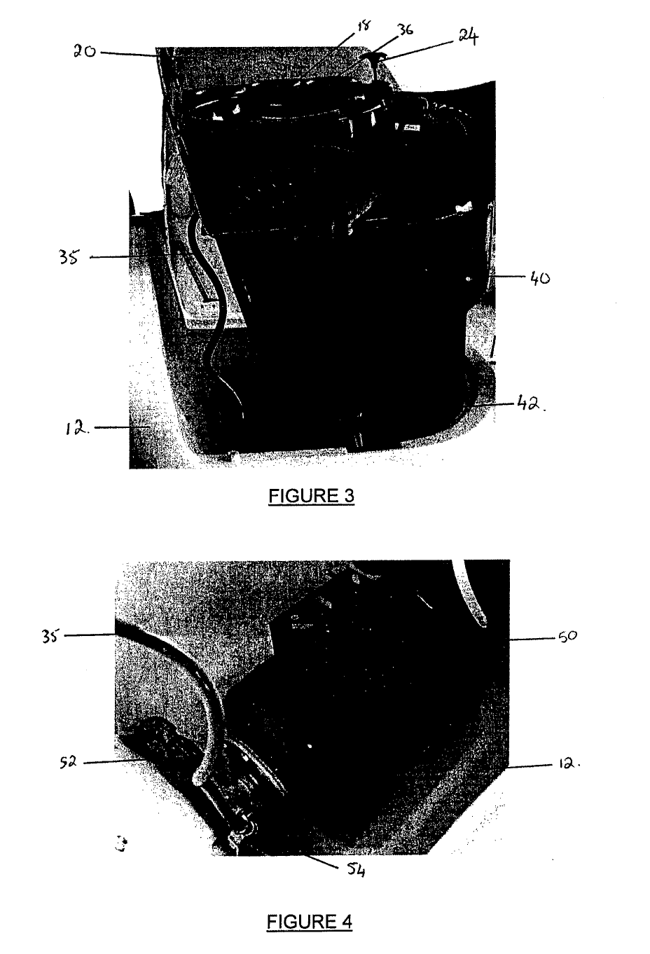

Referring to FIG. 3, a chamber 40, situated below the basin 18, houses the waste water reservoir and the fresh water reservoir. One of the bottle holders 36 includes a hole, through which fresh water may be introduced into the fresh water reservoir. A valve 42 may be opened to drain the waste water from the waste water reservoir when required Referring to FIG. 4 the detergent reservoir 50, is located below the chamber 40. The reservoir 50 includes a pressurised rubber bladder (not shown) in which the detergent is stored under pressure. By storing the liquid detergent under pressure, it may be dispensed through the spray applicator 30 without the need of a compression unit or a power supply.

The reservoir is pressurised to approximately 2 bar pressure by introducing compressed air into the vessel through an attached one-way pneumatic valve 52, prior to filling the bladder with the detergent.

The liquid detergent is then pumped into the pressurised bladder from an external supply until the reservoir is pressurised to approximately 7 bar pressure.

It is envisaged that a pump driven by a motor will pump the detergent into the bladder via the one way valve 52 until a pressure of approximately 7 bar is reached. When it is required to spray detergent onto a vehicle, a second valve 54, attached to hose 35, is opened, allowing the pressurised liquid to flow into the hose 35 and to the spray application 30. Activation of the trigger 32 on the spray applicator 30 allows the liquid to be sprayed out of the nozzle 34.

It is possible for the rubber bladder to be refilled with liquid detergent as and when necessary.

The liquid detergent is a combined wash and wax solution, which is not required to be rinsed off the vehicle.

Numerous modifications to this embodiment are possible, without departing from the scope of the invention.

The invention therefore provides a novel mobile carwash system.

1. A mobile vehicle washing unit comprising a portable dispensing unit capable of retaining and dispensing at least a liquid detergent for application to the body and windows of a vehicle; the dispensing unit including at least one reservoir for storing the liquid detergent under pressure and an applicator for applying the pressurised detergent to the vehicle;
characterised in that the reservoir includes a rubber bladder housed therein under pressure, the bladder being fillable with the liquid detergent.

2. A mobile vehicle washing unit as claimed in claim 1 characterised in that the reservoir is pressurised to approximately 2 bar pressure by introducing compressed air into the reservoir through an attached one-way pneumatic valve.

3. A mobile vehicle washing unit as claimed in claim 1 characterised in that the liquid detergent is pumped into the bladder housed within the reservoir from an external supply until the reservoir is pressurised to approximately 7 bar pressure.

4. A mobile vehicle washing unit as claimed in claim 1 characterised in that the pressure exerted on the liquid detergent by the rubber bladder allows the detergent to be emitted from the bladder via a spray applicator.

5. A mobile vehicle washing unit as claimed in claim 4 characterised in that the spray applicator includes a hose attached to the bladder at one end and to a trigger jet and spray nozzle at the other end.

6. A mobile vehicle washing unit as claimed in claim 1 characterised in that the pressurised rubber bladder is refillable with liquid detergent as and when required.

7. A mobile vehicle washing unit as claimed in claim 1 characterised in that the liquid detergent is a combined wash and wax solution.

8. A mobile vehicle washing unit as claimed in claim 7 characterised in that the wash and wax solution is not required to be rinsed off the vehicle.

9. A mobile vehicle washing unit as claimed in claim 1 characterised in that the detergent is dispensed through the spray applicator without the need of an external power supply or compression unit.

10. A mobile vehicle washing unit as claimed in claim 1 characterised in that the dispensing unit is mounted on wheels.

11. A mobile vehicle washing unit as claimed in claim 10 characterised in that the dispensing unit includes two wheels attached to its undercarriage,

12. A mobile vehicle washing unit as claimed in claim 11 characterised in that the dispensing unit includes a third castor wheel mounted in front of or behind the two wheels.

13. A mobile vehicle washing unit as claimed in claim 1 characterised in that the dispensing unit includes a second reservoir for storing clean water, for use in rinsing cloths and other peripherals associated with the cleaning of the vehicle,

14. A mobile vehicle washing unit as claimed in claim 13 characterised in that the clean water reservoir includes a hand operated manual pump for pumping the water out of the tank.

15. A mobile vehicle washing unit as claimed in claim 13 characterised in that the dispensing unit includes and a third reservoir for storing waste water.

16. A mobile vehicle washing unit as claimed in claim 1 characterised in that the dispensing unit includes a basin and plug for receiving pumped water from the clean water reservoir, the basin being connected to the waste water reservoir.

17. A mobile vehicle washing unit as claimed in claim 1 characterised in that the dispensing unit includes storage compartments for housing additional vehicle cleaning accessories and products.

18. A mobile vehicle washing unit as claimed in claim 1 characterised in that the dispensing unit includes storage space for a portable vacuum cleaner.

19. A portable dispensing unit for housing equipment and materials for washing and cleaning vehicles, the unit comprising; two front wheels attached to its under carriage, and a third castor back wheel; a base supporting three reservoirs and a housing surrounding the base platform, protectively covering the reservoirs held therein; characterised in that at least one of the reservoirs including an internal pressurised rubber bladder.

20. A portable dispensing unit as claimed in claim 19 characterised in that the housing additionally includes a basin and plug located on the exterior top of the housing, for receiving and holding water from the clean water reservoir and connectable to the wastewater reservoir.

21. A portable dispensing unit as claimed in claims 19 characterised in that the housing also includes a lid, hingeably attached to the housing, for covering the basin.

22. A portable dispensing unit as claimed in claim 21 characterised in that the interior of the lid includes storage compartments for storing various vehicle cleaning products and accessories.
